(19) United States
(12) Patent Application Publication
(10) Pub. No.: US 2008/0309868 A1
(43) Pub. Date: Dec. 18, 2008

(54) Customized glasses

(76) Inventor: Donald Eugene Hodgson, Erie, CO (US)

Correspondence Address: Don Hodgson, 400 Young Ct. Unit 5, Erie, CO, 80516, US

(21) Appl. No.: 11/818,150

(22) Filed: Jun. 14, 2007

(51) Int. Cl. G02C 11/02

(52) U.S. Cl. 351/51

(57) ABSTRACT

A pair of glasses where a film is attached to the lens or lenses. On the film artwork is printed.

### FIELD OF THE INVENTION

This invention is directed to sun glasses or eye glasses for the protection from small objects, weather or sun.

### BACK GROUND OF THE INVENTION

There has been no suggestion in prior art to customize glasses.

### BRIEF SUMMARY OF THE INVENTION

This invention relates to glasses wherein a thin film is attached to the lens or lenses of the glasses, on this film is an illustration, photo, or any other form of art or graphics is printed onto this film. This film is attached to lens or lenses of the glasses. The artwork can be seen by a person looking at the front of the glasses. The person wearing the glasses will not see the art and it will not effect their vision. These and other objects or the invention will be more from following more particular description of preferred embodiment illustrated in the accompanying drawings in which reference characters refer to the same parts throughout the various views. The drawings are not necessarily to scale. Emphasis instead being upon the principles of the invention.

### BRIEF DESCRIPTION OF THE DRAWINGS

FIG. 1. Front view of the glasses

FIG. 2. Front view of the film

FIG. 3 Front view of eyeglasses with film attached.

### DETAILED DESCRIPTION OF INVENTION

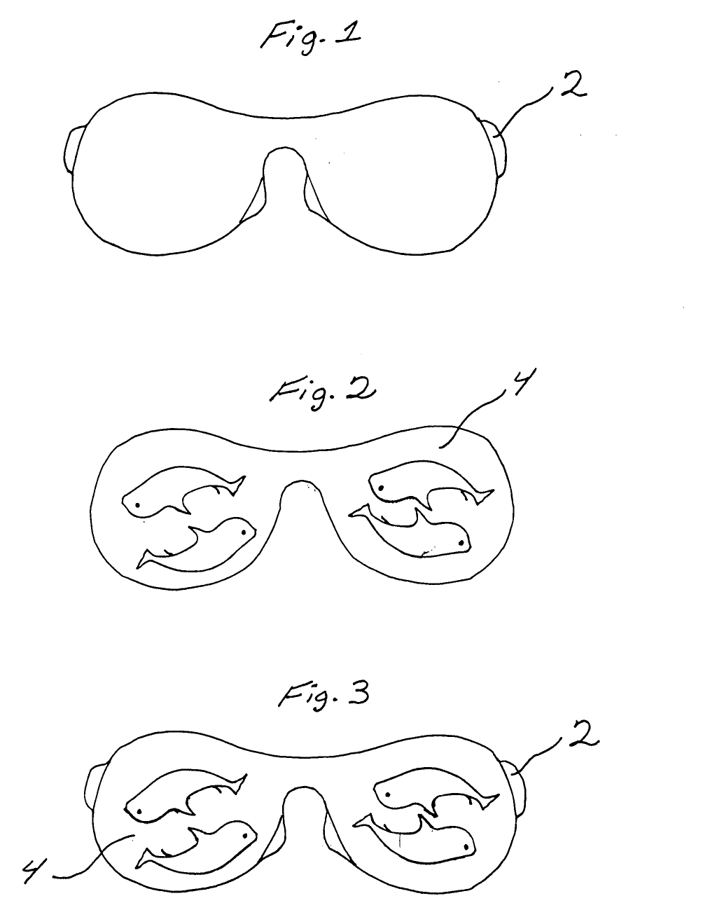

In FIG. 1 There is illustrated a pair of glasses (2)

In FIG. 2. There is illustrated a film (4) that will be attached to glasses (2)

In FIG. 3. There is illustrated the glasses with film (4) attached.

1. A pair of glasses wherein a film that has been printed with some form of artwork, graphics, photo, or simple lettering for means of advertising or promoting a product, person, place, or thing is attached to the lens or lenses by means of optically clear glue.
